(19) United States
(12) Patent Application Publication
(10) Pub. No.: US 2020/0355519 A1
(43) Pub. Date: Nov. 12, 2020

(54) SYSTEMS AND METHODS FOR EVALUATING EXTENDED-RANGE TWIN-ENGINE OPERATIONAL PERFORMANCE STANDARDS DURING VEHICULAR TRAVEL

(71) Applicant: Honeywell International Inc., Morris Plains, NJ (US)

(72) Inventors: Raghu SHAMASUNDAR, Morris Plains, NJ (US); Yi ZHONG, Shanghai (CN); Yong YANG, Morris Plains, NJ (US); Kalimulla KHAN, Morris Plains, NJ (US); Srihari JAYATHIRTHA, Morris Plains, NJ (US)

(21) Appl. No.: 16/404,075

(22) Filed: May 6, 2019

(51) Int. Cl. G01C 23/00; G08G 5/00

(52) U.S. Cl. CPC G01C 23/005; G08G 5/0034; G08G 5/0039; G08G 5/0026

(57) ABSTRACT

Disclosed are systems, methods, and non-transitory computer-readable medium for an Extended-range Twin-engine Operational Performance Standards (ETOPS) flight evaluation. One system may include a dispatcher flight tracker application configured to integrate with one or more data services, in order to predict possible alternate airports and real-time aircraft fuel usage and plan for an ETOPS operation during flight. The dispatcher flight tracker application may present the ETOPS flight evaluation to both the dispatcher and aircraft crew.

### TECHNICAL FIELD

Various embodiments of the present disclosure generally relate to a connected service-oriented architecture of flight planning, and more particularly, to integrating information from numerous sources to effectively plan Extended-range Twin-engine Operational Performance Standards (ETOPS) operation of an aircraft during a flight.

### BACKGROUND

ETOPS has enabled directing routing by allowing aircraft operators to fly beyond a certain amount of time under “one engine out” scenarios to an alternate airport as defined by regulatory policies. To enable an ETOPS operation, an aircraft dispatcher may need to evaluate data from multiple sources before the aircraft is cleared for the ETOPS operation. Aircraft dispatchers may be constrained by the limited time available to optimally plan and compute the real-time ETOPS alternate airport and fuel requirements per aircraft performance. Currently, there is no tool that consolidates all the required information for an ETOPS operation and provides a confirmed decision support to the dispatcher. The present disclosure is directed to overcoming one or more of these issues.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF DISCLOSURE

According to certain aspects of the disclosure, systems and methods are disclosed to integrate all necessary processes to provide a flight dispatcher with an ETOPS flight evaluation using real-time aircraft data.

In one embodiment, a computer-implemented method is disclosed for Extended-range Twin-engine Operational Performance Standards (ETOPS) flight evaluation. The computer-implemented method may comprise: receiving, by a processor, weather data associated with locations along a flight path of an aircraft; receiving, by the processor, aircraft status data of an aircraft; receiving, by the processor, external flight data; determining, by the processor, an operation path of the aircraft based on the received weather data associated with locations along the flight path of the aircraft, the received aircraft status data of the aircraft, and the received external flight data; transforming, by the processor, the determined operation path of the aircraft into a visualization format data; and transmitting, by the processor, the visualization format data to a display of a remote device operated by an operator.

In accordance with another embodiment, a computer-implemented system is disclosed for an Extended-range Twin-engine Operational Performance Standards (ETOPS) flight evaluation. The computer-implemented system may comprise: a memory having processor-readable instructions stored therein; and at least one processor configured to access the memory and execute the processor-readable instructions, which when executed by the at least one processor configures the at least one processor to perform: receiving weather data associated with locations along a flight path of an aircraft; receiving aircraft status data of an aircraft; receiving external flight data; determining an operation path of the aircraft based on the received weather data associated with locations along the flight path of an aircraft, the received aircraft status data of the aircraft, and the received external flight data; transforming the determined operation path of the aircraft into a visualization format data; and transmitting the visualization format data to a display of a remote device operated by an operator.

In accordance with another embodiment, a non-transitory computer-readable medium is disclosed for an Extended-range Twin-engine Operational Performance Standards (ETOPS) flight evaluation. The non-transitory computer-readable medium storing instruction that, when executed by at least one processor, may configure the at least one processor to perform: receiving, by a processor, weather data associated with locations along a flight path of an aircraft; receiving, by the processor, aircraft status data of an aircraft; receiving, by the processor, external flight data; determining, by the processor, an operation path of the aircraft based on the received weather data associated with locations along the flight path of the aircraft, the received aircraft status data of the aircraft, and the received external flight data; transforming, by the processor, the determined operation path of the aircraft into a visualization format data; and transmitting, by the processor, the visualization format data to a display of a remote device operated by an operator.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an overview of the flight dispatcher system for ETOPS evaluation, according to one aspect of the present disclosure.

FIG. 2 depicts a flowchart of an exemplary method 200 for evaluating an ETOPS operation, according to one aspect of the present disclosure.

FIG. 3 depicts a diagram illustrating calculations of an ETOPS route planning, according to one aspect of the present disclosure.

FIG. 4 depicts and exemplary user interface of the dispatcher flight tracker application, according to one aspect of the present disclosure.

FIG. 5 depicts an exemplary user interface of the dispatcher flight tracker application, according to one aspect of the present disclosure.

FIG. 6 depicts another exemplary user interface of the dispatcher flight tracker application, according to one aspect of the present disclosure.

FIG. 7 depicts an exemplary computer device or system, in which embodiments of the present disclosure, or portions thereof, may be implemented, according to one aspect of the present disclosure.

### DETAILED DESCRIPTION OF EMBODIMENTS

ETOPS has enabled extended operations for aircraft operators. ETOPS regulation requires the aircraft and the operators to prove the reliability of such flights and plan for the mitigation of worst case scenario. On the engine front, this rule may ensure very low failure rates by certifying engines and aircrafts for ETOPS operations. On the operational front, this rule may ensure availability of alternate airports and sufficient fuel required to reach the alternate airports under exigent situations.

In addition to normal duties, an aircraft dispatcher may have additional responsibilities during the flight into an ETOPS region. The dispatcher may need to re-evaluate the alternate airports and fuel requirements for worst case scenarios based on real-time conditions such as aircraft state, remaining fuel, airport conditions, etc. If any of the conditions are not suitable for the ETOPS operation, the flight may need to be re-routed appropriately to regular operations. For an ETOPS operation, the dispatcher may need to collate information from several sources in order to compute the alternate airports and fuel requirements per aircraft performance in real-time.

Accordingly, the following embodiments describe system and methods to provide the dispatcher a flight tracker application to plan an ETOPS operation of an aircraft during flight. The flight tracker application may integrate real-time information from a variety of sources along with aircraft state information to predict real-time conditions around the flight. The flight tracker application may compute a high-fidelity prediction decision on the ETOPS operability of the aircraft and may notify the dispatcher of the decision. The flight tracker application may thus significantly reduce the time needed for the dispatcher to evaluate an ETOPS operation from an estimated 35 minutes down to an estimated 1 second to 5 minutes. The flight tracker application should complete all evaluation and the result should be presented to the dispatcher before the aircraft reaches an ETOPS entry point. In addition, if the flight needs to exit the ETOPS operation, the flight tracker application may change the flight plan, generate a new route for a non-ETOPS operation, present the new route to the dispatcher for review, and uplink the new route directly to the aircraft.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

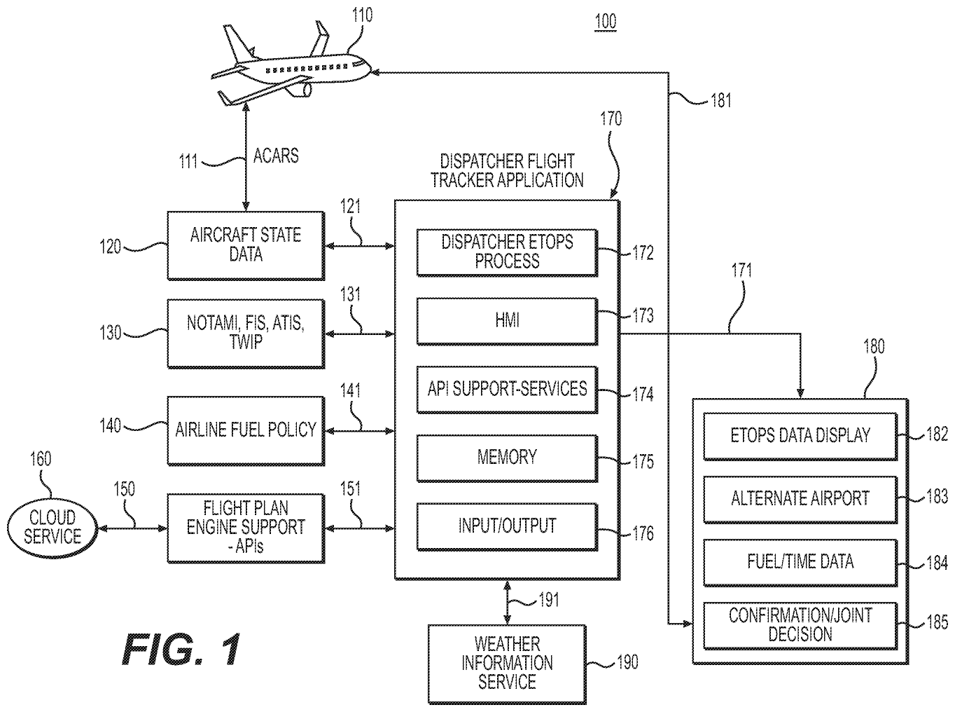

Referring now to the appended drawings, FIG. 1 shows an overview of an exemplary ETOPS flight evaluation environment 100, according to one aspect of the present disclosure. The environment 100 may, for example, comprise an aircraft 110, aircraft state data database 120, a third party data input database 130, an airline fuel policy database 140, a flight plan engine support database 150, a cloud service database 160, a dispatcher flight tracker application 170, an evaluation decision dataset 180, and a weather information service 190. The aircraft 110 may communicate with aircraft state data database 120 via the aircraft communications addressing and reporting system (ACARS) 111. The aircraft state data database 120, third party data input database 130, airline fuel policy database 140 and flight plan engine support database 150 may communicate with the dispatcher flight tracker application 170 via communication links 121, 131, 141, and 151 respectively. The dispatcher flight tracker application 170 may communicate with the weather information service 190 via communication link 191. The aircraft state data 120 may include at least, the aircraft fuel usage data, aircraft fuel flow rate, and aircraft fuel remaining on board.

As shown in FIG. 1, the dispatcher flight tracker application 170 may, for example, include a dispatcher ETOPS process 172, a human machine interface (HMI) 173, API support services 174, a memory 175, and an input/output 176. The evaluation decision dataset 180 may, for example, include an ETOPS data display 182, an alternate airport 183, fuel and time data 184, and a confirmation and joint decision 185. As further shown in FIG. 1, the dispatch flight tracker application 170 may output the evaluation decision dataset 180 via communication link 171. In one embodiment, the dispatcher flight tracker application 170 may be located remotely from the aircraft and may be operated by a dispatcher, i.e. a dispatch center. In another embodiment, the dispatcher flight tracker application 170 may be located at a wireless device onboard the aircraft, i.e. an electronic flight bag (EFB), or a personal electronic device (PED), operated by the crew on the aircraft. The EFB/PED may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

An exemplary operation of environment 100 when an ETOPS operation evaluation is needed will be described herein. The aircraft 110 may transmit aircraft data via ACARS 111 to aircraft state data database 120. The dispatcher flight tracker application 170 may receive input data from the aircraft state data database 120, third party data input database 130, airline fuel policy database 140, flight plan engine support database 150, and weather information service 190 via communications links 121, 131, 141, 151, and 190 respectively. The input of data can be performed automatically or as requested by the dispatcher using the HMI 173. The dispatcher ETOPS process 172 may perform the evaluation using all the received data and then output the determination via communications link 171 to evaluation decision 180. The evaluation output may include display information for the ETOPS data display 182, alternate airport information 183 for the ETOPS operation, fuel and time data information 184 which may include fuel usage, fuel flow, estimated fuel on board at various locations, estimated time of departure, estimated time of arrival, and estimate time enroute, and confirmation and joint decision 185 which may include confirmation for an ETOPS operation approval, an ETOPS operation denial, and a flight path diversion.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., the dispatcher flight tracker application 170, and the evaluation decision 180) may be implemented within a single device, or a single device shown in FIG. 1 (e.g., the dispatcher flight tracker application 170, and the evaluation decision 180) may be implemented as multiple, distributed devices. Additionally, or alternatively, a set of devices (e.g., one or more devices) of environment 100 may perform one or more functions described as being performed by another set of devices of environment 100.

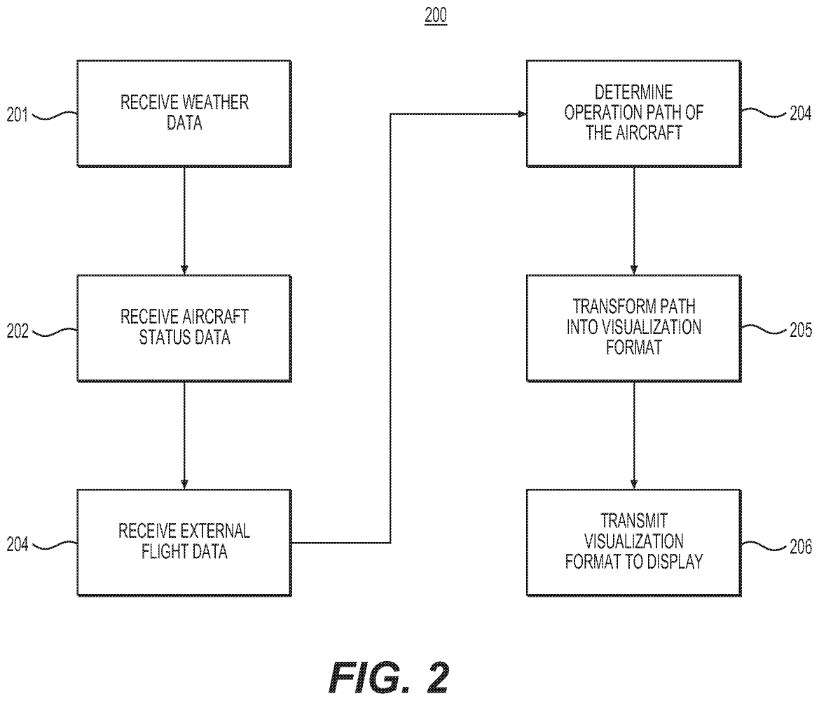

FIG. 2 depicts a flowchart of an exemplary method 200 for evaluating an ETOPS operation, according to one aspect of the present disclosure.

First, at step 201, the exemplary method 200 may begin with receiving weather data from weather information service 190 via communications link 191. The weather data may include wind speed, temperature, humidity, weather conditions and any other relevant weather data. At step 202, ETOPS planning data may be received from aircraft state data database 120, airline fuel policy database 140 and flight plan engine support database 150. Aircraft state data database 120 may include aircraft speed, altitude, fuel usage, fuel flow, estimated fuel on board, and any other relevant data. At step 204, data from third party data database 130 may be received. Third party data 130 may include data from external sources such as A Notice to Airmen (NOTAMs), Automatic Terminal Information Service (ATIS), Air Traffic Control (ATC), Automatic Dependent Surveillance-Broadcast (ADS-B), and any other relevant dynamic data. At step 205, the data received at step 201, step 202, and step 204 may then be input into the dispatcher flight tracker application 170 via input/output 176 to evaluate the path of the aircraft. At step 206, the dispatcher ETOPS process 172 may process the input data from memory 175 to determine an ETOPS operation and may transform the aircraft flight path into a visualization format. At step 207, the visualization format may be transmitted to the evaluation decision dataset 180 via input/output 176 for display. At the evaluation decision dataset 180, the visualization data may be displayed on the ETOPS data display 182, which may indicate an alternate airport 183 for a non-ETOPS and ETOPS operation, fuel and time data 184 of the aircraft, and a confirmation and joint decision 185 which may indicate to the dispatcher whether the aircraft is approved for the ETOPS operation, not approved for the ETOPS operation, or any diversions to the flight plan.

The number and arrangement of modules, devices, and networks shown in FIG. 2 are provided as an example. In practice, there may be additional modules and devices, fewer modules, devices and/or networks, different modules, devices and/or networks, or differently arranged modules, devices and/or networks than those shown in FIG. 2. Furthermore, two or more devices included in environment 200 of FIG. 2 may be implemented within a single device, or a single device in the environment 200 of FIG. 2 may be implemented as multiple, distributed devices. Additionally, or alternatively, a set of devices (e.g., one or more devices) of environment 200 may perform one or more functions described as being performed by another set of devices of environment 200.

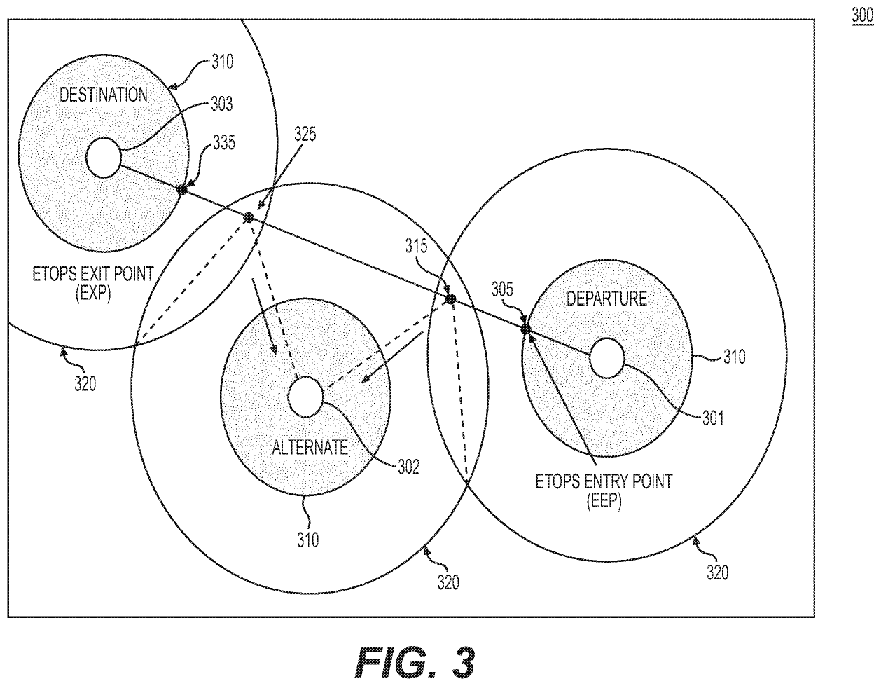

FIG. 3 shows a diagram illustrating calculations of an ETOPS route planning, according to one aspect of the present disclosure.

As shown in FIG. 3, the diagram 300 may include a departure airport 301, an alternate airport 302, a destination airport 303, an ETOPS entry point (EEP) 305, an equal time point between the departure airport and the alternate airport (ETP 1) 315, an equal time point between the alternate airport and the destination airport (ETP 2) 325, an ETOPS exit point (EXP) 335, 60-minute travel time non-ETOPS ranges 310, and 180-minute travel time ETOPS ranges 320. As depicted in FIG. 3, the departure airport, destination airport and alternate airport may all be designated with both the 60-minute travel time non-ETOPS range and the 180-minute travel time ETOPS range.

When an aircraft takes off from the departure airport 301, it may first travel within the 60-minute travel time non-ETOPS range 310 towards the EEP 305. Before the aircraft arrives at EEP 305, the dispatcher may need to evaluate and determine if the aircraft is cleared for an ETOPS operation. If the aircraft is cleared for the ETOPS operation, the aircraft may be allowed to travel on the flight path towards ETP 1 315. When the aircraft arrives at ETP 1 315, the aircraft may be at equal travel time between the departure airport 301 and the alternate airport 302. If the aircraft does not need to be diverted to the alternate airport 302, the aircraft may travel towards ETP 2 325. At ETP 2 325, the aircraft may be equal travel time away from the alternate airport 302 and the destination airport 303. If the aircraft does not need to be diverted to the alternate airport 302, the aircraft may travel towards EXP 335, at which point the aircraft may exit the ETOPS operation and travel within the 60-minute travel time non-ETOPS range 310 towards the destination airport 303 for arrival.

Although FIG. 3 shows an exemplary diagram 300, in other implementations, the ETOPS route planning may involve additional diagrams, fewer diagrams, different diagrams, or differently arranged diagrams than those depicted in FIG. 3. Additionally, the computations illustrated in two or more of the diagrams may be performed in parallel.

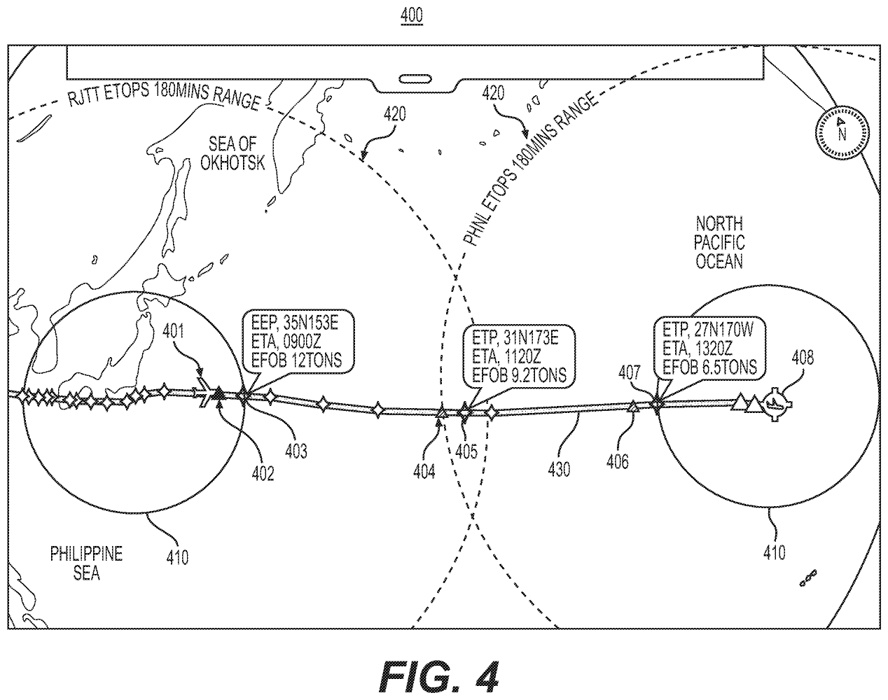

FIG. 4 depicts and exemplary user interface 400 of the dispatcher flight tracker application, according to one aspect of the present disclosure.

As shown in FIG. 4, the user interface 400 may include an aircraft 401, an ETOPS evaluation point 402, an EEP 403, an ETP evaluation point 404, an ETP 405, an EXP evaluation point 406, an EXP 407, a destination airport 408, 60-minute travel time non-ETOPS ranges 410, a 180-minute travel time ETOPS ranges 420, and an ETOPS route 430. The user interface 400 may provide the flight dispatcher the ability to view the EEP 403 and the results of the ETOPS evaluation well before the EEP 403 and predict the amount of fuel required. When the aircraft 401 is near the ETOPS evaluation point 402, the user interface 400 may indicate to the dispatcher that the aircraft 401 is within 10-minute travel time range to the EEP 403 and the flight tracker application 170 may begin evaluating the weather conditions in both the departure airport and the destination airport 408 which covers the 180-minute travel time ETOPS route. The flight tracker application 170 may also evaluate the other conditions defined by the airlines, such as NOTAM, fuel on board based on the flight plan, and weather on route to determine whether the fuel onboard is sufficient to arrive at the destination airport considering the weather conditions, or whether there is an adverse weather on route that might require the aircraft 401 to be re-routed. Once the flight tracker application 170 completes the evaluation, the evaluation decision may be presented to the dispatcher on the ETOPS data display 182 and an ACARS message may be prepared for the dispatcher to uplink to the aircraft 401 to transmit the decision. The flight tracker application 170 may present the information clearly to the dispatcher, for example the flight tracker application 170 may display the estimated time of arrival to the EEP, ETP, and the estimated fuel on board at each respective locations (e.g., EEP with 12 tons of fuel, ETP with 9.2 tons of fuel, and ETP with 6.5 tons of fuel). The flight tracker application 170 may also present the decision in a plurality of formats to the dispatcher, the display may present the decision using a color icon (e.g., green aircraft icon means enter into an ETOPS), or the display may present the decision using text alert (e.g., “enter into ETOPS”).

Although FIG. 4 shows an exemplary user interface 400, in some implementations, the user interface 400 may include additional user interface elements, fewer user interface elements, different user interface elements, or differently arranged user interface elements than those depicted in FIG. 4.

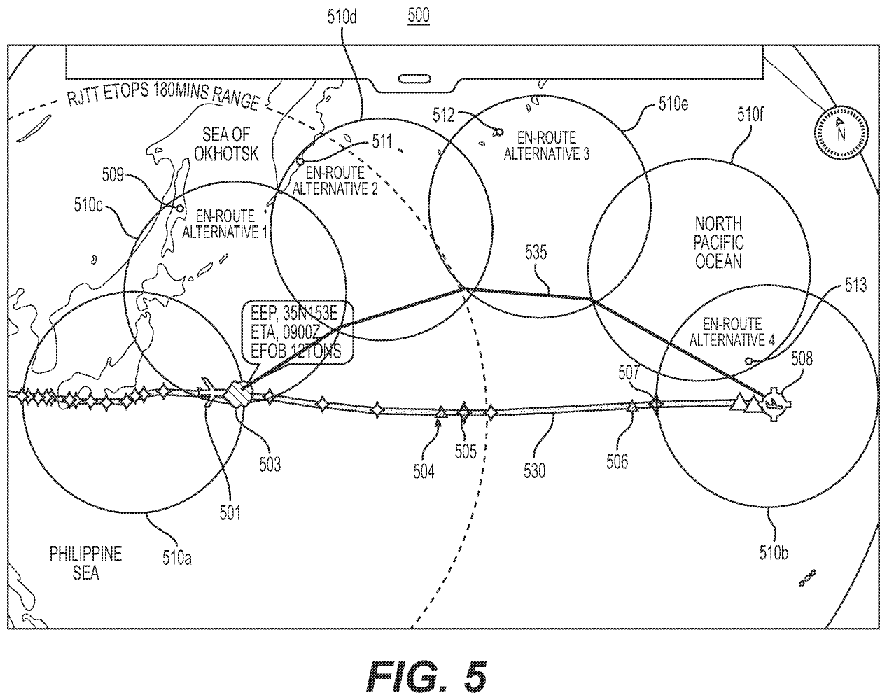

FIG. 5 depicts an exemplary user interface 500 of the dispatcher flight tracker application, according to one aspect of the present disclosure. Notably, in one embodiment, the user interface 500 may depict a user interface that has progressed from the user interface 400 of FIG. 4.

As illustrated in FIG. 5, the user interface 500 may include an aircraft 501, an EEP 503, an ETP evaluation point 504, an ETP 505, an EXP evaluation pint 506, an EXP 507, a destination airport 508, a 60-minute travel time non-ETOPS ranges 510a to 510f, en-route alternative airports 509, 511, 512, 513, an ETOPS route 530, and a non-ETOPS route 535. In FIG. 5, the aircraft 501 is shown to have already arrived at the ETOPS evaluation point 402 illustrated in FIG. 4. The dispatcher flight tracker application 170 may go through an evaluation process by considering conditions defined by the airlines, such as NOTAM, fuel on board based on the flight plan and weather condition en route. In this instance, the flight tracker application 170 may calculate the fuel required for a non-ETOPS route in real-time based on aircraft performance and actual weather forecast such as, for example, wind speed and temperature, and may also evaluate alternative airports that are available based on aircraft performance, weather forecast, and any geo-political restrictions. The flight tracker application 170 may also allow the dispatcher to set alternate airports availability and may use those availabilities as the highest priority when it selects the alternate airports for the non-ETOPS route 535.

The flight tracker application 170 may then present the results of the evaluation. In the context of FIG. 5, the flight tracker application 170 has determined that the aircraft 501 cannot be cleared for an ETOPS operation. Therefore, instead of the aircraft 501 cleared for the ETOPS route 530, the aircraft 501 must operate the non-ETOPS route 535. As can be see in FIG. 5, the non-ETOPS route 535 may be within the 60-minute travel time non-ETOPS ranges 510a to 510f of en-route alternative airports 509, 511, 512, and 513. In other words, the aircraft 501 may operate within one hour from a diversion airport for the entire flight path. The flight tracker application 170 may present the non-ETOPS route to the dispatcher for approval before transmitting to the aircraft 501 for review by the fly crew. The flight tracker application 170 may present the decision in a plurality of formats to the dispatcher to reduce confusion or ambiguity. For example, the flight tracker application 170 may use color icons, i.e. showing a red “X” at EEP 503 to notify the dispatcher that the aircraft 501 is not allowed to enter the ETOPS operation. The may present the decision using a text alert (e.g., flashing an alert notifying the dispatcher that the aircraft 501 is not cleared for the ETOPS operation). The flight tracker application 170 may display the non-ETOPS route so that the non-ETOPS route is distinctive from the other elements in the user interface.

Although FIG. 5 shows an exemplary user interface 500, in some implementations, the interface 500 may include additional user interface elements, fewer user interface elements, different user interface elements, or differently arranged user interface elements than those depicted in FIG. 5.

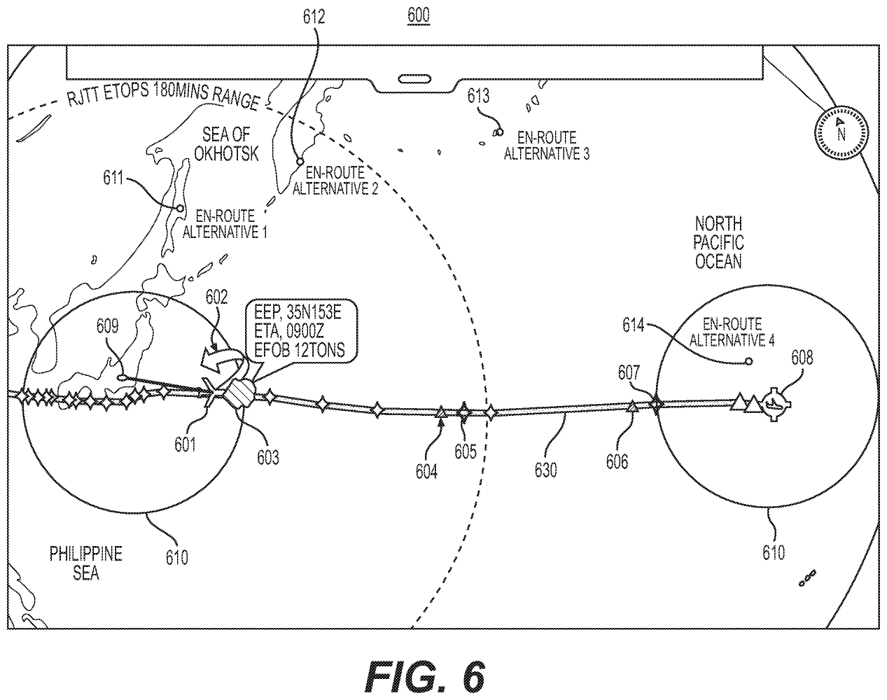

FIG. 6 depicts another exemplary user interface 600 of the dispatcher flight tracker application, according to one aspect of the present disclosure. Notably, in one embodiment, the user interface 600 may depict a user interface that has progressed from the user interface 400 of FIG. 4.

As illustrated in FIG. 6, the exemplary user interface 600 may include an aircraft 601, a diversion route 602, an EEP 603, an ETP evaluation point 604, an ETP 605, an EXP evaluation point 606, an EXP 607, a destination airport 608, a departure airport 609, a 60-minute travel time non-ETOPS range 610, en-route alternative airports 611, 612, 613, 614, and an ETOPS route 630. In FIG. 6, the aircraft is shown to have already arrived at the ETOPS evaluation point 402 illustrated in FIG. 4. The dispatcher flight tracker application 170 may go through an evaluation process by considering conditions defined by the airlines, such as NOTAM, fuel on board based on the flight plan and weather condition en route. In this instance, the flight tracker application 170 may calculate the fuel required for a non-ETOPS route in real-time based on aircraft performance and actual weather forecast such as, for example, wind speed and temperature, and may also evaluate alternative airports that are available based on aircraft performance, weather forecast, and any geo-political restrictions. The flight tracker application 170 may then present the results of the evaluation. In the context of FIG. 6, the flight tracker application 170 has determined that the aircraft 601 needs to divert back to the departure airport 609. There might be various reasons for the flight tracker application 170 to determine a diversion back to the departure airport 609. For example, the aircraft 601 might not have enough fuel onboard, there might be severe weather conditions along the flight path, there might not be alternative airports available due to weather or geo-political restrictions for the aircraft 601 to operate on a non-ETOPS route. The flight tracker application 170 may present the evaluation decision to the dispatcher for approval before transmitting to the aircraft for review by the flight crew. The flight tracker application 170 may present the decision in a plurality of formats to the dispatcher to reduce confusion or ambiguity. For example, the flight tracker application 170 may use color icons (e.g., showing a red “X” at EEP 603) to notify the dispatcher that the aircraft 601 is not allowed to continue on the flight path. The flight tracker application 170 may display a return arrow 602 to notify the dispatcher that the aircraft 601 must divert back to the departure airport 609. The flight tracker application 170 may present the decision using a text alert (e.g., flashing an alert to notify the dispatcher that the aircraft 601 must return to the departure airport 609).

Although FIG. 6 shows an exemplary user interface 600, in some implementations, the interface 600 may include additional user interface elements, fewer user interface elements, different user interface elements, or differently arranged user interface elements than those depicted in FIG. 6.

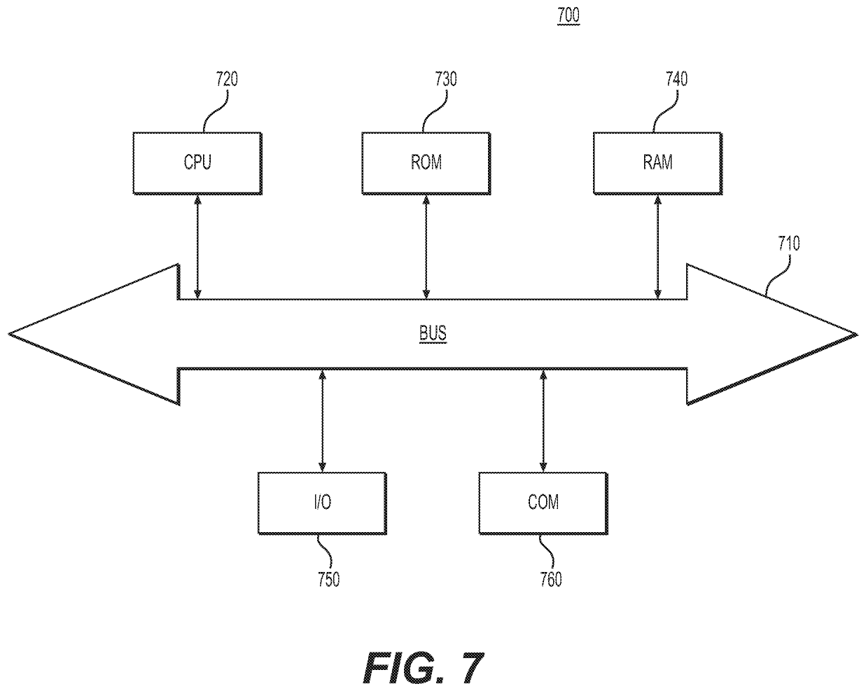

FIG. 7 depicts a high-level functional block diagram of an exemplary computer device or system, in which embodiments of the present disclosure, or portions thereof, may be implemented, e.g., as computer-readable code. In some implementations, dispatcher flight tracker application 170 (depicted in FIG. 1) may be implemented with device 700. Additionally, or alternatively, evaluation decision 180 may each correspond to device 700. Additionally, each of the exemplary computer servers, databases, user interfaces, modules, and methods described above with respect to FIGS. 1-6 can be implemented in device 700 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-6.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-6, may be implemented using device 700. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 7, device 700 may include a central processing unit (CPU) 720. CPU 720 may be any type of processor device including, for example, any type of microprocessor device. As will be appreciated by persons skilled in the relevant art, CPU 720 also may be a single processor in a multi-core/multiprocessor system, such system operating alone, or in a cluster of computing devices operating in a cluster or server farm. CPU 720 may be connected to a data communication infrastructure 710, for example, a bus, message queue, network, or multi-core message-passing scheme.

Device 700 also may include a main memory 740, for example, random access memory (RAM), and also may include a secondary memory 730. Secondary memory 730, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 730 may include other similar means for allowing computer programs or other instructions to be loaded into device 700. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 700.

Device 700 also may include a communications interface (“COM”) 760. Communications interface 760 allows software and data to be transferred between device 700 and external devices. Communications interface 760 may include a modem, a network interface (such as an Ethernet card), a communications port, a PCMCIA slot and card, or the like. Software and data transferred via communications interface 760 may be in the form of signals, which may be electronic, electromagnetic, optical, or other signals capable of being received by communications interface 760. These signals may be provided to communications interface 760 via a communications path of device 700, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 700 also may include input and output ports 750 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

What is claimed is:

1. A computer-implemented method for an Extended-range Twin-engine Operational Performance Standards (ETOPS) flight evaluation, the method comprising:
receiving, by a processor, weather data associated with locations along a flight path of an aircraft;
receiving, by the processor, aircraft status data of the aircraft;
receiving, by the processor, external flight data;
determining, by the processor, an operation path of the aircraft based on the received weather data associated with locations along the flight path of the aircraft, the received aircraft status data of the aircraft, and the received external flight data;
transforming, by the processor, the determined operation path of the aircraft into a visualization format data; and
transmitting, by the processor, the visualization format data to a display of a remote device operated by an operator.

2. The method of claim 1, further comprising:
uplinking, by the processor, the determined operation path of the aircraft to the aircraft prior to the aircraft arriving at an operation path entry point.

3. The method of claim 1, wherein the aircraft status data of the aircraft comprise at least one of: fuel usage data, fuel flow data, an amount of fuel remaining, a number of operational engines, or a speed.

4. The method of claim 1, wherein the external flight data comprise data from at least one of: a flight information system, an automatic terminal information service system, a terminal weather information system, an air traffic control system, an automatic dependent surveillance broadcast, or a notices to airmen.

5. The method of claim 1, wherein the remote device is remotely located from the aircraft.

6. The method of claim 1, wherein the remote device comprises a wireless device onboard the aircraft.

7. The method of claim 1, further comprising:
generating, by the processor, a notification alert included with the visualization format data, wherein the notification alert comprises at least one of: a color icon, a text, a symbol, or a picture.

8. A computer-implemented system for an Extended-range Twin-engine Operational Performance Standards (ETOPS) flight evaluation, the computer-implemented system comprising:
a memory having processor-readable instructions stored therein; and
at least one processor configured to access the memory and execute the processor-readable instructions, which when executed by the at least one processor configure the at least one processor to perform:
receiving weather data associated with locations along a flight path of an aircraft;
receiving aircraft status data of an aircraft;
receiving external flight data;
determining an operation path of the aircraft based on the received weather data associated with locations along the flight path of the aircraft, the received aircraft status data of the aircraft, and the received external flight data;
transforming the determined operation path of the aircraft into a visualization format data; and
transmitting the visualization format data to a display of a remote device operated by an operator.

9. The computer-implemented system of claim 8, further comprising uplink the determined operation path of the aircraft to the aircraft prior to the aircraft arriving at an operation path entry point.

10. The computer-implemented system of claim 8, wherein the aircraft status data of an aircraft is at least one of, fuel usage data, fuel flow data, an amount of fuel remaining, number of operational engines, or speed.

11. The computer-implemented system of claim 8, wherein the external flight data is data from at least one of, flight information system, automatic terminal information services, terminal weather information for pilots, air traffic control, automatic dependent surveillance broadcast, or notices to airmen.

12. The computer-implemented system of claim 8, wherein the remote device is at a remote location separate from the aircraft.

13. The computer-implemented system of claim 8, wherein the remote device is a wireless device onboard the aircraft.

14. The computer-implemented system of claim 8, further comprising a notification alert included with the visualization format data wherein the notification alert is at least one of, color icon, text, symbol, or picture.

15. A non-transitory computer-readable medium for an Extended-range Twin-engine Operational Performance Standards (ETOPS) flight evaluation, the non-transitory computer-readable medium storing instruction that, when executed by at least one processor, configure the at least one processor to perform:
receiving, by a processor, weather data associated with locations along a flight path of an aircraft;
receiving, by the processor, aircraft status data of an aircraft;
receiving, by the processor, external flight data;
determining, by the processor, an operation path of the aircraft based on the received weather data associated with locations along the flight path of the aircraft, the received aircraft status data of the aircraft, and the received external flight data;
transforming, by the processor, the determined operation path of the aircraft into a visualization format data; and
transmitting, by the processor, the visualization format data to a display of a remote device operated by an operator.

16. The non-transitory computer-readable medium of claim 15, further comprising uplinking the determined operation path of the aircraft to the aircraft prior to the aircraft arriving at an operation path entry point.

17. The non-transitory computer-readable medium of claim 15, wherein the aircraft status data of an aircraft is at least one of, fuel usage data, fuel flow data, an amount of fuel remaining, number of operational engines, or speed.

18. The non-transitory computer-readable medium of claim 15, wherein the external flight data is data from at least one of, flight information system, automatic terminal information services, terminal weather information for pilots, air traffic control, automatic dependent surveillance broadcast, or notices to airmen.

19. The non-transitory computer-readable medium of claim 15, wherein the remote device is at a remote location separate from the aircraft.

20. The non-transitory computer-readable medium of claim 15, wherein the remote device is a wireless device onboard the aircraft.
